(19) United States
(12) Patent Application Publication
(10) Pub. No.: US 2011/0027666 A1
(43) Pub. Date: Feb. 3, 2011

(54) METAL-AIR BATTERY WITH ION EXCHANGE MATERIALS

(75) Inventors: Trygve Burchardt, Maennedorf (CH); Michael Lanfranconi, Horgen (CH)

Correspondence Address: FOLEY & LARDNER LLP, 777 EAST WISCONSIN AVENUE, MILWAUKEE, WI, 53202-5306, US

(73) Assignee: ReVolt Technology Ltd.

(21) Appl. No.: 12/847,901

(22) Filed: Jul. 30, 2010

Related U.S. Application Data
(60) Provisional application No. 61/230,550, filed on Jul. 31, 2009.
(60) Provisional application No. 61/304,273, filed on Feb. 12, 2010.

(51) Int. Cl. H01M 4/06; H01M 8/22

(52) U.S. Cl. 429/406; 429/405

(57) ABSTRACT

A metal-air battery includes a metal anode including at least one of zinc, aluminum, magnesium, iron, and lithium. The metal-air battery also includes an ion exchange material provided within the battery for controlling material transport within the battery. The ion exchange material may be provided at one or more locations within the battery, including within an air electrode, within a material coupled to the air electrode, as a separate film or membrane, within pores of a polymeric separator, or elsewhere.

### CROSS-REFERENCE TO RELATED PATENT APPLICATIONS

The present application claims priority to and the benefit of U.S. Provisional Patent Application No. 61/230,550, filed Jul. 31, 2009, and U.S. Provisional Patent Application No. 61/304,273, filed Feb. 12, 2010, the entire disclosures of which are incorporated herein by reference.

### BACKGROUND

The present application relates generally to the field of batteries and components for batteries. More specifically, the present application relates to metal-air batteries or cells that include an ion exchange material.

Metal-air batteries include a negative metal electrode (e.g., zinc, aluminum, magnesium, iron, lithium, etc.) and a positive electrode having a porous structure with catalytic properties for an oxygen reaction (typically referred to as the air electrode for the battery). An electrolyte is used to maintain high ionic conductivity between the two electrodes. For alkaline metal-air batteries (i.e., having an alkaline electrolyte), the air electrode is usually made from thin, porous polymeric material (e.g., polytetrafluoroethylene) bonded carbon layers. To prevent a short circuit of the battery, a separator is provided between the negative electrode (anode) and the positive electrode (cathode).

On discharging metal-air batteries, oxygen from the atmosphere is converted to hydroxyl ions in the air electrode. The hydroxyl ions then migrate to the metal electrode, where they cause the metal of the negative electrode to oxidize. The desired reaction in the air electrode involves the reduction of oxygen, the consumption of electrons, and the production of hydroxyl ions. The hydroxyl ions migrate through the electrolyte towards the metal electrode, where oxidation of the metal occurs, forming oxides and liberating electrons. In a secondary (i.e., rechargeable) metal-air battery, charging converts hydroxyl ions to oxygen in the air electrode, releasing electrons. At the metal electrode, the metal oxides or ions are reduced to form the metal while electrons are consumed.

Metal-air batteries provide significant energy capacity benefits. For example, metal-air batteries have several times the energy storage density of lithium-ion batteries, while using globally abundant and low-cost metals (e.g., zinc) as the energy storage medium. The technology is relatively safe (non-flammable) and environmentally friendly (non-toxic and recyclable materials may be used). Since the technology uses materials and processes that are readily available in the U.S. and elsewhere, dependence on scarce resources such as oil may be reduced.

There are several challenges that face designers of metal-air batteries, and in particular metal-air batteries that are intended to be rechargeable. One such challenge relates to undesirable shape changes in the battery, including the formation of dendrites at the air electrode due to the diffusion of zinc and zinc hydroxides (e.g., zincate (Zn(OH)₄²⁻)) within the battery. Dendrite formation is defined as the growth of zinc (or other metals) in needle or branch-like structures into the electrolyte between the anode and the cathode. This type of Zn growth during charging may cause the zinc to penetrate through the pores in a porous separator, which may cause short circuiting and battery failure when the zinc contacts the air electrode.

Another issue relates to the use of conventional porous polymeric separators, which may allow zincate to diffuse between the metal electrode and the air electrode. Zincate ions are very soluble in alkaline electrolytes such as KOH, and will diffuse though a porous separator. In some cases with high zincate concentrations on the air electrode side of the separator, deposits of zinc oxide may occur once the solubility concentration of zincate is reached and the ZnO begins to precipitate. The solubility of zincate is closely linked to the OH⁻ concentration, and one possible explanation for the deposition may be that OH⁻ concentration varies during charge and discharge on the air electrode. Zincate deposition on the air electrode can cause failure of the battery.

Another challenge relates to the fact that catalysts or impurities from the air electrode may leach into the electrolyte, which may cause gassing at the metal electrode and degrade the performance of the battery. Also with respect to the air electrode, over time the air electrode may break down. It would be desirable to maintain the stability of the catalysts and any impurities so that they remain at the air electrode so that the air electrode remains intact over the life of the battery, and to the extent that any catalysts or impurities do become separated from the air electrode, to prevent them from being transported to the metal electrode to reduce the tendency of gassing at the metal electrode.

Yet another challenge relates to the formation and maintenance of a stable three-phase boundary at the air electrode. Over time, water included in the electrolyte may slowly flood the air electrode, leading to an increased diffusion path for oxygen into the structure and possibly the subsequent failure of the air electrode. Flooding of the system results in increased ohmic resistance and subsequently a loss in the power density and efficiency. It would be advantageous to prevent or reduce the occurrence of such flooding.

It would be advantageous to provide an improved battery and structures/features therefore that address one or more of the foregoing challenges. It would also be advantageous to provide an improved battery that includes a separator that prevents dendrites from extending between an air electrode and a metal electrode. It would also be advantageous to provide an improved battery that includes a material that reduces the diffusion rate of zincate through the battery. It would also be advantageous to provide a metal-air battery having a longer lifespan than is presently available with current metal-air batteries. It would also be advantageous to provide a metal-air battery that may be used in a variety of applications, including, but not limited to, large scale and small scale applications. Other advantageous features of the battery disclosed herein will be apparent to those reviewing the present disclosure.

### SUMMARY

An exemplary embodiment relates to a metal-air battery that includes a metal anode comprising at least one of zinc, aluminum, magnesium, iron, and lithium. The metal-air battery also includes an ion exchange material provided within the battery for controlling material transport within the battery.

Another exemplary embodiment relates to a metal-air battery that includes a metal anode, an air electrode, and an ion exchange material provided within the battery for controlling material transport within the battery. The metal-air battery is a rechargeable battery.

Another exemplary embodiment relates to a rechargeable metal-air battery that includes a zinc anode, an air electrode, and an ion exchange separator provided intermediate the zinc anode and the air electrode.

### BRIEF DESCRIPTION OF THE DRAWINGS

FIG. 1 is a perspective view of a metal-air battery in the form of a coin cell according to an exemplary embodiment.

FIG. 2 is a cross-sectional view of the metal-air battery shown in FIG. 1.

FIG. 3 is a is a cross-sectional view of a metal-air battery similar to that shown in FIG. 1 according to another exemplary embodiment.

FIG. 4 is a is a cross-sectional view of a metal-air battery similar to that shown in FIG. 1 according to another exemplary embodiment.

FIG. 5 is a cross-sectional view of an air electrode according to an exemplary embodiment.

FIG. 6 is a perspective view of a metal-air battery having a prismatic configuration according to an exemplary embodiment.

FIG. 7 is a cross-sectional view of the metal-air battery shown in FIG. 6.

FIG. 8 is detail cross-sectional view of the cross-section shown in FIG. 7.

FIG. 9 is a partially exploded perspective view of a flow battery according to an exemplary embodiment.

FIG. 10 is a perspective view of a reaction tube for a flow battery according to another exemplary embodiment.

FIGS. 11-20 are graphs illustrating various test data.

### DETAILED DESCRIPTION

According to an exemplary embodiment, a metal-air battery includes an ion exchange material that is intended to help address challenges relating to undesirable material transport within the battery. According to one exemplary embodiment, the ion exchange material may be provided in the form of a separator or membrane, or may be included within a conventional separator. According to other exemplary embodiments, the ion exchange material may be provided as a film or membrane that is applied to (e.g., laminated on) the surface of an air electrode. According to other exemplary embodiments, the ion exchange material may be mixed with the materials used to form one or more layers of the air electrode (e.g., one or more layers of the active layer or gas diffusion layer of the air electrode) so that the ion exchange materials are incorporated directly within the air electrode. It should be understood that any combination of the foregoing may also be used according to various other exemplary embodiments. For example, a metal-air battery may include both an ion exchange material provided on the surface of an air electrode in addition to having one or more layers of the air electrode itself including an ion exchange material incorporated therein. Other possibilities and combinations will be apparent to those reviewing the present disclosure, and all such possibilities are intended to be included within the scope of the present disclosure.

The metal-air battery may have any desired configuration, including, but not limited to, coin or button cells, prismatic cells, cylindrical cells (e.g., AA, AAA, C, or D cells in addition to other cylindrical configurations), flow cells, fuels cells, etc. Further, the metal-air battery may be a primary (disposable, single-use) or a secondary (rechargeable) battery. Rechargeable metal-air batteries are available due to the development of bifunctional air electrodes and the utilization of rechargeable anode materials.

Various advantages may be obtained by incorporating an ion exchange material into a metal-air battery as described herein. For example, the presence of an ion exchange material may advantageously reduce or prevent migration of zincate (Zn(OH)₄²⁻) toward the air electrode, thus reduce the tendency to form dendrites that may cause short circuits within the cell between the metal electrode and the air electrode. Limiting the zincate diffusion may provide more even depositions through the bulk of the Zn electrode, fewer surface reactions, and thus fewer tendencies for dendrites and shape changes. The ion exchange material may also mitigate or prevent the leaching of catalysts or impurities from the air electrode to the metal electrode, thus reducing the tendency of the metal electrode to experience undesirable gassing that may degrade the performance of the battery over time. According to certain exemplary embodiments, the ion exchange material may also help to prevent breakdown of the air electrode and to assist in the maintenance of a stable three phase boundary at the air electrode.

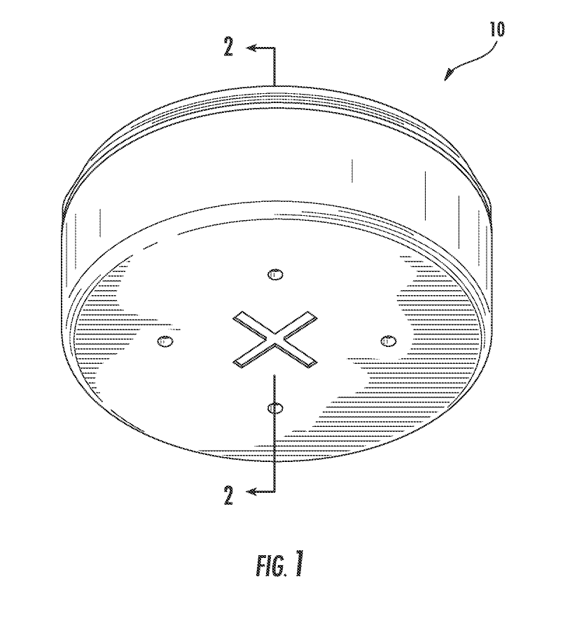

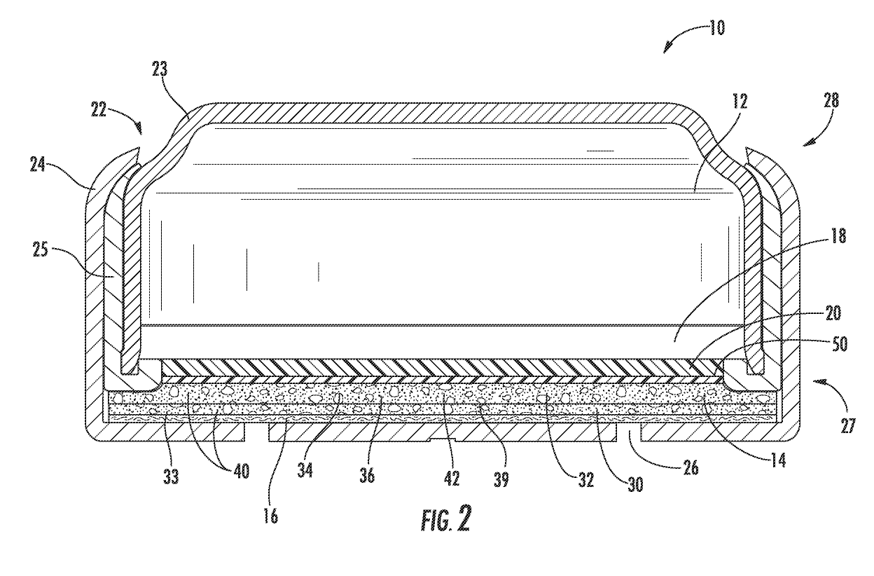

Referring to FIGS. 1-2, a metal-air battery 10 shown as a coin or button cell is illustrated according to an exemplary embodiment.

Referring to FIG. 2, the battery 10 includes a metal electrode 12, an air electrode 14 including a gas diffusion layer 30 and an active layer 32 (the active layer possibly also including an oxygen evolution layer), an electrolyte 18, a separator 20, an oxygen distribution layer 16 (e.g., a non-woven fibrous material intended to distribute oxygen entering the system evenly throughout the air electrode 14), and an enclosing structure shown as a housing 22 according to an exemplary embodiment. A member or element provided as a layer, film, or membrane that includes an ion exchange material is located on or adjacent to the air electrode 14 (for ease of reference, such layer will be referred to herein as an ion exchange membrane 50).

According to an exemplary embodiment, the battery 10 is a zinc-air battery. According to other exemplary embodiments, the battery 10 may use other metals in place of the zinc, including, but not limited to, aluminum, magnesium, iron, lithium, cadmium, and/or a metal hydride. Examples of metal hydride materials include the AB₅ or AB₂ structure types where the “ABₓ” designation refers to the ratio of A elements and B elements. For the AB₅ type, A may be a combination of La, Ce, Pr and Nd, and, for the AB₂ type, A may be Ti, Zr or a combination of Ti and Zr. For both structure types, B may be a combination of Ni, Mn, Co, Al and Fe.

Referring further to FIG. 2, the housing 22 (e.g., case, container, casing, etc.) is shown including a base 23 and a lid 24 according to an exemplary embodiment. A seal 25 (e.g., a molded nylon sealing gasket, etc.) is formed/disposed generally between the base 23 (e.g., can, etc.) and the lid 24 (e.g., cap, cover, top, etc.) to help maintain the relative positions of the base 23 and the lid 24. The seal 25 also helps prevent undesirable contacts (e.g., causing a short circuit) and/or leakage. The lid 24 includes one or more holes 26 at a first portion 27 of the housing 22 generally opposite a second portion 28. The metal electrode 12 is shown disposed within housing 22 at or proximate to the second portion 28. The air electrode 14 is shown disposed at or proximate to the first portion 27, and spaced a distance from the metal electrode 12. The holes 26 (e.g., apertures, openings, slots, recesses, etc.) provide for interaction between the air electrode 14 and the oxygen in the surrounding atmosphere (e.g., air), with the oxygen distribution layer 16 allowing for relatively even distribution of the oxygen to the air electrode 14. The surrounding atmosphere may be ambient air or one or more air flows may be directed into or across the holes 26. The housing may have any number of shapes and/or configurations according to other exemplary embodiments. Any number of holes having any of a variety of shapes, sizes, and/or configurations may be utilized according to other exemplary embodiments.

The separator 20 is a thin, porous, film or membrane formed of a polymeric material and is disposed substantially between the metal electrode 12 and the air electrode 14 according to an exemplary embodiment. The separator 20 is configured to prevent short circuiting of the battery 10. In some exemplary embodiments, the separator 20 includes or is made of polypropylene or polyethylene that has been treated to develop hydrophilic pores that are configured to fill with the electrolyte 18. In other exemplary embodiments, the separator may be made of any material configured to prevent short circuiting of the battery 10 and/or that includes hydrophilic pores.

The electrolyte 18 is shown disposed substantially between the metal electrode 12 and the air electrode 14 according to an exemplary embodiment. The electrolyte 18 (e.g., potassium hydroxide (“KOH”) or other hydroxyl ion-conducting media) is not consumed by the electrochemical reaction within the battery 10, but, rather, is configured to provide for the transport of hydroxyl ions (“OH⁻”) from the air electrode 14 to the metal electrode 12 during discharge, and, where the battery 10 is a secondary system, to provide for transport of hydroxyl ions from the metal electrode 12 to the air electrode 14 during charge. The electrolyte 18 is disposed within some of the pores of the metal electrode 12 and some of the pores of the air electrode 14. According to other exemplary embodiments, the distribution and location of the electrolyte may vary (e.g., the electrolyte may be disposed in the pores of the metal electrode and not the pores of the air electrode, etc.).

According to an exemplary embodiment, the electrolyte 18 is an alkaline electrolyte used to maintain high ionic conductivity between the metal electrode and the air electrode. According to other exemplary embodiments, the electrolyte may be any electrolyte that has high ionic conductivity and/or high reaction rates for the oxygen reduction/evolution and the metal oxidation/reduction (e.g., NaOH, LiOH, etc.). According to still other embodiments, the electrolyte may include salt water or others salt-based solutions that give sufficient conductivity for the targeted applications (e.g., for marine/military applications, etc.).

According to an exemplary embodiment, the metal electrode and the electrolyte are combined (e.g., mixed, stirred, etc.). The combination of the metal electrode and the electrolyte may form a paste, powder, pellets, slurry, etc.

The air electrode 14 includes one or more layers with different properties and a current collector 39 (e.g., a metal mesh, which also helps to stabilize the air electrode). In some exemplary embodiments, a plurality of air electrodes may be used for a single battery. In some of these exemplary embodiments, at least two of the air electrodes have different layering schemes and/or compositions. In other exemplary embodiments, the current collector is other than a metal mesh current collector (e.g., a foam current collector).

Referring further to FIG. 2, the air electrode 14 includes a gas diffusion layer 30 (sometimes abbreviated “GDL”) and an active layer 32 (sometimes abbreviated “AL”) according to an exemplary embodiment.

The gas diffusion layer 30 is shown disposed proximate to the holes 26 in the second portion 28 of the housing 22, substantially between the active layer 32 and the housing 22. The gas diffusion layer 30 includes a plurality of pores 33 according to an exemplary embodiment. The gas diffusion layer 30 is configured to be porous and hydrophobic, allowing gas to flow through the pores while acting as a barrier to prevent liquid flow. In some exemplary embodiments, both the oxygen reduction and evolution reactions take place in one or more air electrode layers closely bonded to this layer.

The active layer 32 is disposed substantially between the metal electrode 12 and the holes 26 in the second portion 28 of the housing 22 according to an exemplary embodiment. The active layer 32 has a double pore structure that includes both hydrophobic pores 34 and hydrophilic pores 36. The hydrophobic pores help achieve high rates of oxygen diffusion, while the hydrophilic pores 36 allow for sufficient electrolyte penetration into the reaction zone for the oxygen reaction (e.g., by capillary forces). According to other exemplary embodiments, the hydrophilic pores may be disposed in a layer separate from the active layer, e.g., an oxygen evolution layer (sometimes abbreviated “OEL”). Further, other layers or materials may be included in/on or coupled to the air electrode. Further, other layers may be included in/on or coupled to the air electrode, such as a gas selective membrane.

The air electrode 14 may include a combination of pore forming materials. In some exemplary embodiments, the hydrophilic pores of the air electrode are configured to provide a support material for a catalyst or a combination of catalysts (e.g., by helping anchor the catalyst to the reaction site material) (e.g., cobalt on carbon, silver on carbon, etc.). According to one exemplary embodiment, the pore forming material includes activated carbon or graphite (e.g., having a BET surface area of more than 100 m²·g⁻¹). According to other exemplary embodiments, pore forming materials such as high surface area ceramics or other materials may be used. More generally, using support materials (or pore forming materials) that are not carbon-based avoids CO₂ formation by those support materials when charging at high voltages (e.g., greater than 2V). One example is the use of high surface area silver (Ag); the silver can be Raney Ag, where the high surface area is obtained by leaching out alloying element from a silver alloy (e.g., Ag—Zn alloy). According to still other exemplary embodiments, any material that is stable in alkaline solutions, that is conductive, and that can form a pore structure configured to allow for electrolyte and oxygen penetration, may be used as the pore forming material for the air electrode. According to an exemplary embodiment, the air electrode internal structures may be used to manage humidity and CO₂.

Referring further to FIG. 2, the current collector 39 is disposed between the gas diffusion layer 30 and the active layer 32 of the air electrode 14 according to an exemplary embodiment. According to another exemplary embodiment, the current collector may be disposed on the active layer (e.g., when a non-conductive layer or no gas diffusion layer is included in the air electrode). The current collector 39 may be formed of any suitable electrically-conductive material.

The air electrode 14 further includes a binding agent or combination of binding agents 40, a catalyst or a combination of catalysts 42, and/or other additives (e.g., ceramic materials, high surface area metals or alloys stable in alkaline media, etc.). According to an exemplary embodiment, the binding agents 40 are included in both the active layer 32 and the gas diffusion layer 30, and the catalysts 42 are included in the active layer. According to other exemplary embodiments, the binding agents, catalysts, and/or other additives may be included in any, none, or all of the layers of the air electrode. In other exemplary embodiments, the air electrode may not contain one or more of a binding agent or combinations of binding agents, a catalyst or a combination of catalysts, and/or other additives.

The binding agents 40 are intended to bind the components of the air electrode together while still allowing the air electrode to have relatively high oxygen diffusion rates. The binding agents 40 may also cause pores in the air electrode 14 to become hydrophobic to limit the amount of liquid transport through the air electrode.

The binding agents 40 may include, for example, polymeric materials such as polytetrafluoroethylene (PTFE), polyethylene (PE), polypropylene (PP), polyisobutylene (PIB), thermoplastics such as polybutylene terephthalate (PBT) or polyamides, polyvinylidene fluoride (PVDF), silicone-based elastomers such as polydimethyl siloxane (PDMS) or rubber materials such as natural rubber (NR), ethylene propylene rubber (EPM) or ethylene propylene diene monomer rubber (EPDM), or combinations thereof.

According to an exemplary embodiment, binding agents such as PP and/or PE may be used as the only binders in a particular layer (replacing, for example, PTFE). According to other exemplary embodiments, binding agents such as PP and/or PE may be used in combination with PTFE in a particular layer to allow the benefits of PTFE (which provides, for example, excellent oxygen transport) to be balanced with the benefits of PP and/or PE (which, as described below, act to increase the mechanical strength of the air electrode).

The binding agents 40 are intended to provide increased mechanical strength for the air electrode 14, while providing for maintenance of relatively high diffusion rates of oxygen (e.g., comparable to more traditional air electrodes that typically use polytetrafluoroethylene (“PTFE”)). The binding agents 40 may also cause pores in the air electrode 14 to become hydrophobic. According to one exemplary embodiment, the binders include PTFE in combination with other binders. According to other exemplary embodiments, other polymeric materials may also be used (e.g., thermoplastics such as polybutylene terephthalate or polyamides, polyvinylidene fluoride, silicone-based elastomers such as polydimethylsiloxane, or rubber materials such as ethylene propylene, and/or combinations thereof).

According to an exemplary embodiment, the binding agents 40 provide mechanical strength sufficient to allow the air electrode 14 to be formed in a number of manners, including, but not limited to, one or a combination of injection molding, extrusion (e.g., screw extrusion, slot die extrusion, etc.), stamping, pressing, utilizing hot plates, calendering, etc. This improved mechanical strength also enables air electrode 14 to be formed into any of a variety of shapes (e.g., a tubular shape, etc.). The ability to form the air electrode into any of a variety of shapes may assist in the manufacture of metal-air batteries for applications such as Bluetooth headsets, applications for which tubular batteries are used or required (e.g., size AA batteries, size AAA batteries, size D batteries), etc.

In an exemplary embodiment, the battery 10 is a secondary battery (e.g., rechargeable) and the air electrode 14 is a bifunctional air electrode. According to other exemplary embodiments, the battery 10 may be a primary battery (e.g., single use, disposable, etc.).

The catalysts 42 are configured to improve the reaction rate of the oxygen reactions within the battery, including the oxygen reduction and evolution reactions. According to some exemplary embodiments, catalytically active metals or oxygen-containing metal salts are used (e.g., Pt, Pd, Ag, Co, Fe, MnO₂, KMnO₄, MnSO₄, SnO₂, Fe₂O₃, CoO, Co₃O₄, etc.). According to other exemplary embodiments, catalysts may include, but are not limited to, WC, TiC, CoWO₄, FeWO₄, NiS, WS₂, La₂O₃, Ag₂O, Ag, spinels (i.e., a group of oxides of general formula AB₂O₄, where A represents a divalent metal ion such as magnesium, iron, nickel, manganese and/or zinc and B represents trivalent metal ions such as aluminum, iron, chromium and/or manganese) and perovskites (i.e., a group of oxides of general formula AXO₃, where A is a divalent metal ion such as cerium, calcium, sodium, strontium, lead and/or various rare earth metals, and X is a tetrahedral metal ion such as titanium, niobium and/or iron where all members of this group have the same basic structure with the XO₃ atoms forming a framework of interconnected octahedrons). According to other exemplary embodiments, a combination of more than one of the foregoing materials may be used.

According to an exemplary embodiment, the air electrode 14 is formed in a three-step process. Each layer of the multi-layer air electrode 14 is formed separately. First, the desired component elements of each layer are mixed together. The pore forming materials, the catalysts, the binding materials and/or other additives are mixed under the influence of mechanical, thermal, or mechanical and thermal energy. In this process it is desirable that the materials be well distributed. If the mixture contains a hydrophobic binding agent, then this binding agent forms a three dimensional network connecting the powders into an agglomerate. The mixture or the agglomerate is then typically extruded and/or calendered into a layer. Secondly, one or more layers, typically having differing properties (e.g., the gas diffusion layer and the active layer), are combined using heat and/or pressure (e.g., by calendering and/or pressing). Third, the current collector is pressed or calendered into the combined layers (e.g., into the active layer, into the gas diffusion layer, between the active layer and the gas diffusion layer, etc.). According to other embodiments, however, the air electrode may be formed using other processes.

According to an exemplary embodiment, a dry mixing process is utilized in the first step to form the layers of air electrode 14. In a dry mixing process, all of the ingredients of a layer are mixed together in the form of dry powders. According to an exemplary embodiment, a dry process utilizes PTFE binders having a particle size below 1 mm as a binder. In a case where carbon itself does not form the pore structure, an additional pore forming aid such as ammonium bicarbonate may be used to create the gas diffusion layer and/or the oxygen evolution layer.

According to other exemplary embodiments, a wet mixing process may instead be utilized. In a wet mixing process, one or more solvents are added at the beginning or during the mixing process, or, alternatively, one or more ingredients may be used in the form of a dispersion or suspension. The solvent(s) are typically subsequently removed (e.g., directly after the mixing process or in a later state of the production process) (e.g., by using a heating/drying process). According to an exemplary embodiment, a wet process utilizes PTFE that is suspended in water as a binder and a pore forming aid or a carbon material in the gas diffusion layer is used to form pores.

According to still another exemplary embodiment, the various individual layers may be made using different methods. For example, some of the layers may be produced using a dry mixing process, while others may be produced using a wet process. According to yet still another exemplary embodiment, it is possible to combine both dry and wet processes for the different layers and the production may be performed in a continuous production line according to PCT publication WO 2005/004260, the disclosure of which is incorporated herein by reference.

An oxygen evolution layer may be included in the air electrode. According to an exemplary embodiment, the oxygen evolution layer may include 2 to 15 percent binding agent by weight and 25 to 65 percent catalyst(s) by weight. The remainder of the oxygen evolution layer may include a high surface area carbon and/or graphite material and possibly some other additives.

An exemplary embodiment of an air electrode formation method utilizing a dry mixing process will now be discussed. According to this method, the active layer is prepared using a mixture of 15 percent PTFE by weight (e.g., in powder form with a particle size below 1 mm from Lawrence Industries of Thomasville, N.C. as a binding agent), 70 percent high surface area carbon (e.g., XC 500 from Cabot) by weight as a pore forming agent, and 15 percent manganese sulfate (e.g., MnSO₄ from Prolabo of France) by weight as a catalyst. The binding agent, the pore forming agent, and the catalyst are mixed together (e.g., in a single-shaft rotary mixer at approximately 1,000 rpm) to form a substantially homogeneous mixture. The mixture is heated to a desired temperature. When the powder mixture reaches the desired temperature, the powder is milled to form an agglomerate. For example, the mixture may be heated to a desired temperature at or near 90° C. and milled at approximately 1,000 rpm for 1 hour, or the mixture may be heated to a lower initial temperature, but milled at a higher rpm (e.g., 10,000 rpm). The agglomerate is pressed into a brick (e.g., a brick of about 2 mm thickness) and then calendered into a sheet (e.g., of about 0.5 mm thickness). According to other exemplary embodiments, the temperatures, milling rates and times, and other parameters may vary depending on the particular materials used and other factors.

The gas diffusion layer is formed using a mixture of 25 percent PTFE by weight (e.g., in powder form with a particle size below 1 mm from Lawrence Industries of Thomasville, N.C.) as a binding agent and 75 percent ammonium bicarbonate by weight (e.g., with a particle size below 10 μm from Sigma-Aldrich, Inc.) as a pore forming agent. The binding agent and the pore forming agent are mixed at a desired temperature (e.g., typically below a maximum temperature of 40° C.) in a single-shaft rotary mixer (e.g., for 2 hours at 1,500 rpm) to form an agglomerate. The agglomerate is pressed into a brick (e.g., of about 2 mm thickness) and then calendered into a sheet (e.g., of about 1 mm thickness).

An exemplary embodiment of an air electrode formation method utilizing a wet mixing process will now be discussed. According to this method, the active layer is prepared using 15 percent PTFE by weight in a suspension containing 60 percent PTFE by weight dispersed in water (e.g., from Sigma-Aldrich, Inc.) as a binding agent, 65 percent high surface area carbon (e.g., XC 500 from Cabot) by weight as a pore forming agent, and 20 percent manganese sulfate (e.g., MnSO₄ from Prolabo of France) by weight as catalysts. The high surface area carbon is mixed with both catalysts in water. Separately, the PTFE suspension is mixed with water. The PTFE suspension is then added to the carbon suspension and mixed to form a slurry agglomerate. The slurry is then mixed (e.g., in an ultrasonic bath for 30 minutes) and subsequently dried (e.g., at 300° C. for 3 hours) to remove any surfactants. The dried mixture is then agglomerated and a hydrogen treated naphtha with a low boiling point (e.g., Shellsol D40 from Shell Chemicals of London) is added to form a paste. Finally, the paste is calendered into a thin layer to form the active layer.

The hydrophobic gas diffusion layer may be formed by the same method according to an exemplary embodiment. In this layer only high surface area carbon (65 percent by weight) and PTFE (35 percent by weight) are used. The final layer is relatively thin (e.g., having a thickness of about 0.8 mm).

The active layer and the gas diffusion layer are then coupled (e.g., by calendering) to form the air electrode (e.g., having a total thickness of 0.8 mm). Finally, a current collector (e.g., nickel mesh) is pressed into the air electrode (e.g., at 70 bars and at a temperature of between approximately 80° C. and 320° C., and preferably approximately 300° C.) between the active layer and the gas diffusion layer. The air electrode may then be dried (e.g., at 70° C. for 8 hours) to create the hydrophobic porosity of the gas diffusion layer.

According to other exemplary methods of forming and constructing an air electrode and the layers thereof, the layers may be formed to have a variety of thickness and/or compositions. Further, the layers may be coupled by any of a number of methods known in the art.

According to an exemplary embodiment, the battery 10 utilizes an ion exchange material that is generally selective for the transport of either cations or anions. According to a particular embodiment, the ion exchange material is selective only to anions, including but not necessarily limited to hydroxyl (OH⁻) ions (in such a case, the ion exchange material may be referred to as an anion exchange material). The anion exchange material is intended to be active to prevent cations and particles from passing between the air electrode and the metal electrode of the battery. According to an exemplary embodiment, the ion exchange material may also act to limit the ability of certain anionic species (e.g., zincate) from passing between the air electrode and the metal electrode. Without wishing to be bound to a particular theory, it is believed that the selectivity for certain types of anions may depend at least in part on the size of the anion, so that larger anions such as zincate may be less likely to traverse the ion exchange material, while smaller anions such as OH⁻ may readily traverse the material.

According to an exemplary embodiment, the ion exchange material is provided in the form of an ion exchange membrane 50 (e.g., film, sheet, layer, etc.) such as that shown in FIG. 2. For example, the ion exchange membrane may be provided in the form of a Fumion AM, a Fumion AP, or a Fumion APrf ion exchange membrane, each of which are commercially available from FuMA-Tech GmbH of St. Ingbert, Germany. According to an exemplary embodiment, the Fumion AM and Fumion AP membranes may have a thickness of approximately 50 micrometers and the Fumion APrf may have a thickness of approximately 65 micrometers, although the thicknesses of the membranes may vary according to other exemplary embodiments. It will be appreciated that other types of ion exchange membranes may be used in place of or in addition to the foregoing membrane types. Additionally, although FIG. 2 illustrates a single ion exchange membrane 50, it should be understood that more than one such membrane (e.g., two or more layers, etc.) of the same or differing types of ion exchange membranes may be used according to other exemplary embodiments, and may be disposed adjacent to one another or may be spaced a distance apart.

The ion exchange membrane is provided as a solid polymer film or sheet that limits (e.g., controls, regulates, etc.) the transport of materials within the battery. During the process by which the ion exchange membrane 50 is attached to the air electrode (e.g., in a lamination process or other process that applies heat and/or pressure), some of the ion exchange material will soak into the air electrode. This in turn fills some of the pores with a plastic material, and may help to provide additional stability for the three phase boundary of the air electrode (e.g., by helping to separate the oxygen reduction reaction from the oxygen evolution reaction). According to an exemplary embodiment, the ion exchange membrane 50 is configured to be stable in an alkaline solution, has relatively high conductivity over a temperature rage of 10° C. to 300° C.

According to an exemplary embodiment, the ion exchange membrane 50 may be soaked in an electrolyte (e.g., KOH) prior to assembling it with the air electrode 14. For example, the ion exchange membrane 50 may be dipped into a KOH solution and, while still wet, may be coupled or joined (e.g., laminated onto) the air electrode 14 by heat pressing, hot sealing, or other suitable methods. The pre-soaking of the ion exchange membrane is intended to activate the ion exchange material by providing a source of OH⁻ ions for the ion exchange membrane. According to other exemplary embodiments, the ion exchange membrane may not be pre-soaked in an electrolyte, in which case electrolyte from within the cell may slowly soak into the membrane after assembly of the cell to activate the ion exchange membrane.

According to another exemplary embodiment, rather than using commercially-available ion exchange membranes, the ion exchange material may be formed directly onto the surface of the air electrode to form the ion exchange membrane or may be formed on another surface and transferred to the surface of the air electrode as described above with respect to commercially-available membranes. For example, according to one exemplary embodiment, a solution of ion exchange material in a solvent (e.g., Fumion AM ion exchange material in a solvent of N′N-Dimethylformamide (DMF)) may be spread onto a tray as a film. An optional sheet of material (e.g., a 50 micrometer film of Mylar, commercially available from DuPont) may be provided on the tray to protect the tray while casting the film. The film may then be dried (e.g., under ambient conditions, and under a fume hood according to an exemplary embodiment) for a period of time (e.g., 1.5 to 2.0 hours) until the film may be easily peeled off of the tray (or off of the sheet of material). The thickness of the resulting film may be selected based on desired performance parameters, and is a function of the amount of material applied to the surface to form the film (e.g., according to other exemplary embodiments, a deposited film thickness of 200 micrometers may shrink to approximately 70 micrometers after it is dried). According to an exemplary embodiment, the film has a thickness of between approximately 10 and 200 micrometers, although other thicknesses are possible according to other exemplary embodiments. The film may then be applied to an air electrode (e.g., on the active layer side) by hot pressing (e.g., for approximately 2 minutes at 80 bar and a temperature of 70° C., although the parameters may differ depending on factors such as the thickness of the film, the composition of the film, and other factors). The air electrodes may then be assembled into a battery along with an oxygen distribution layer or diffuser on the gas diffusion side of the air electrode, a separator soaked in an alkaline electrolyte such as 11M KOH (e.g., a nonwoven separator such as a PPAS-14 separator commercially available from Shanghai ShiLong Hi-Tech Co., Ltd Chinese Academy of Science (CAS) of the People's Republic of China), a microporous separator (e.g., a 3401 separator commercially available from Celgard of Charlotte, N.C.), and an electrolyte and metal anode (e.g., provided as a metal paste including zinc and an alkaline electrolyte such as KOH).

According to another exemplary embodiment, a similar process as described in the preceding paragraph may be used, with the material used to form the film further including a deep eutectic solvent (e.g., at 5-10 weight percent, although other percentages may be used according to other exemplary embodiments). A deep eutectic solvent (DES) is an ionic solvent that is a mixture of two or more components that forms a eutectic with a melting point much lower than either of the individual components (e.g., quaternary ammonium salts with hydrogen donors such as amines and carboxylic acids; chlorine chloride and urea; etc.). Compared to ordinary solvents, deep eutectic solvents also have a low volatility, are non-flammable, are relatively inexpensive to produce, and may be biodegradable. One example of such a material is a DES formed of a mixture of choline chloride(2-hydroxyethyl-trimethylammonium chloride) and urea (e.g., in a 1:2 mole ratio). Choline chloride has a melting point of 302° C. while urea has a melting point of 133° C. The eutectic mixture of the two components, however, melts at a temperature as low as 12° C. Other deep eutectic solvents of choline chloride are formed with malonic acid (melting point of 0° C.), phenol (melting point of −40° C.) and glycerol (i.e., glycerine) (melting point of −35° C.). According to various exemplary embodiments, the DES may be a mixture of glycerol and zinc bromide, a mixture of glycerol and zinc iodide, a mixture of glycerol and a hydrochloric salt of ethylamine, a mixture of urea and choline chloride, a mixture of urea, choline chloride, and sodium sulfite, or a mixture of glycerol and acetylcholine chloride. According to some exemplary embodiments, a deep eutectic solvent may be combined with choline hydroxide and/or sodium sulfate. According to other exemplary embodiments, the deep eutectic solvent may include a first component that comprises a hydrogen bond donor and a second component that comprises a metal salt or a nitrogen salt (e.g., a halide-containing salt of amines or metals such as transition metals). According to various exemplary embodiments, the first component may be a hydroxyl, an amide, an amine, an aldehyde, a carboxylic acid, an organic acid, a urea, a thiourea, a diol, a glycerol, a choline chloride, a ethylammonium chloride, a choline bromide, a terabutylammonium chloride, a triethylbenzylammonium chloride, a zinc chloride, a acetylcholine chloride, a malonic acid, a formamide, an arabinose, a glucose, a xylose, or a combination thereof.

According to an exemplary embodiment, the ion exchange membrane 50 may be effective to help maintain the mechanical integrity of the surface of the active layer by forming a polymeric material that extends into pores of the air electrode during the lamination process. Because the ion exchange membrane 50 also acts to reduce the tendency of the air electrode 14 to flood since it will prevent electrolyte from entering the air electrode 14, the ion exchange membrane 50 may also help to maintain a stable three phase boundary within the air electrode 14 that would be compromised by flooding of the electrode.

Instead of or in addition to including the ion exchange material within an ion exchange membrane such as the ion exchange membrane 50 shown in FIG. 2, according to other exemplary embodiments, an ion exchange material may be utilized elsewhere within the battery, as will now be described.

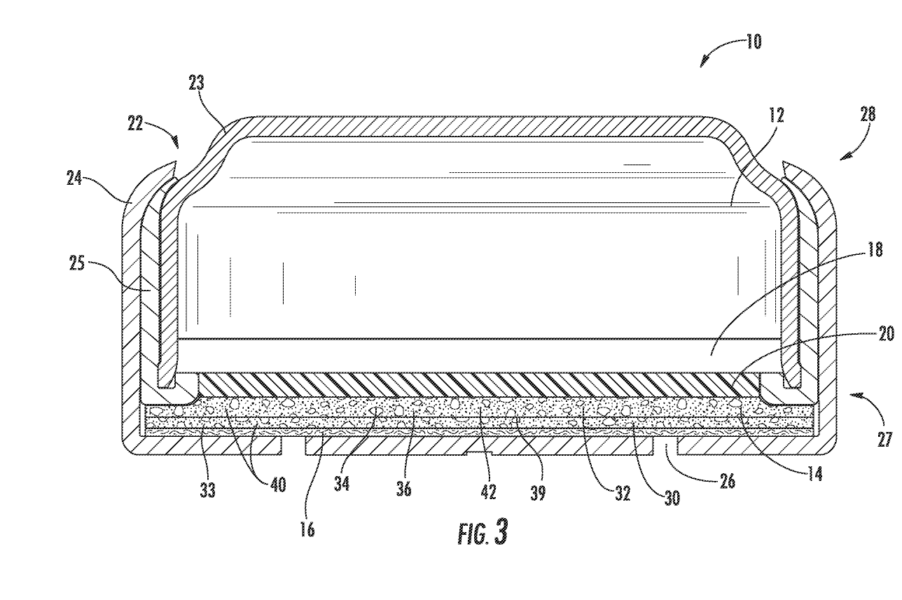

FIG. 3 is a cross-sectional view of a battery similar to that shown in FIG. 2, with like reference numerals representing like elements. Unlike the battery shown in FIG. 2, the battery shown in FIG. 3 does not include an ion exchange membrane. Instead, the ion exchange material may be incorporated within other components of the battery or may be substituted for certain components.

For example, according to an exemplary embodiment, the separator 20 may be replaced with (or used in conjunction with) a separator that is configured to act as an ion exchange membrane or film (hereinafter referred to as an “ion exchange separator”). The ion exchange separator may be purchased or manufactured as a solid polymer film as described above with respect to the ion exchange membrane shown in FIG. 2, and may have any desired thickness that may be suitable for the particular metal-air battery configuration. The use of an ion exchange separator provides similar benefits to those described above with respect to the ion exchange membrane 50 in that the ion exchange separator is selective to hydroxyl ion transfer and may act to reduce or eliminate transport of zincate and dendrite formation along with reducing or eliminating gassing at the metal electrode by preventing oxygen transport to the metal electrode. Activation of the ion exchange separator may be accomplished in a similar manner as described above with respect to the ion exchange membrane.

According to another exemplary embodiment, the ion exchange separator may be a more conventional nonwoven or porous polymeric separator (e.g., a PPAS-14 separator commercially available from Shanghai ShiLong Hi-Tech Co., Ltd Chinese Academy of Science (CAS) of the People's Republic of China or a 3401 separator commercially available from Celgard of Charlotte, N.C.) in which the pores of the separator are filled with an ion exchange material (e.g., Fumion AM, AP, APrf, or other suitable ion exchange materials) to provide the separator with the advantages associated with an ion exchange membrane. For example, the ion exchange material may be provided in solution and the separator may be dipped into the solution to fill the pores. The resulting separator will be a solid polymeric separator with channels filled with ion exchange material that provide for selective ion transport through the separator. In contrast to a conventional separator that readily allows for materials such as zincate, catalysts and impurities from the air electrode, and other materials to pass therethrough, a separator that is pretreated with the ion exchange material would advantageously be configured to only allow ions (e.g., anions) to pass through, thus providing similar advantages to the use of an ion exchange membrane as described above. Activation of the ion exchange separator may be accomplished in a similar manner as described above with respect to the ion exchange membrane.

It should be noted that an ion exchange separator (e.g., having a configuration similar to the ion exchange membrane 50 or as a conventional separator that is pretreated with an ion exchange material) may be included as one of several layers that are provided between the metal electrode and the air electrode. For example, as shown in FIG. 3, layers 60, 62, and 64 are provided between the metal electrode 12 and the air electrode 14, with layer 64 provided in contact with the electrolyte 18 for the battery. According to an exemplary embodiment, the layer 60 is a porous polymeric separator that is soaked in electrolyte (e.g., KOH) and/or a deep eutectic solvent. The second layer 62 is an ion exchange separator. The third layer 64 is a porous polymeric separator that has been soaked in electrolyte (e.g., KOH). According to other exemplary embodiments, the number, positions, and types of the various layers may differ. For example, according to an exemplary embodiment, there may be five layers between the electrolyte 18 and the air electrode 14, with the layers including a first separator soaked with a deep eutectic solvent in contact with the air electrode 14, a second separator soaked in an electrolyte and/or DES in contact with the first separator, a third separator soaked in an electrolyte in contact with the second separator, an ion exchange separator (or a separator having an ion exchange material with its pores) in contact with the third separator, and another separator soaked in an electrolyte between the electrolyte 18 and the ion exchange separator. Any of a variety of other combinations are also possible.

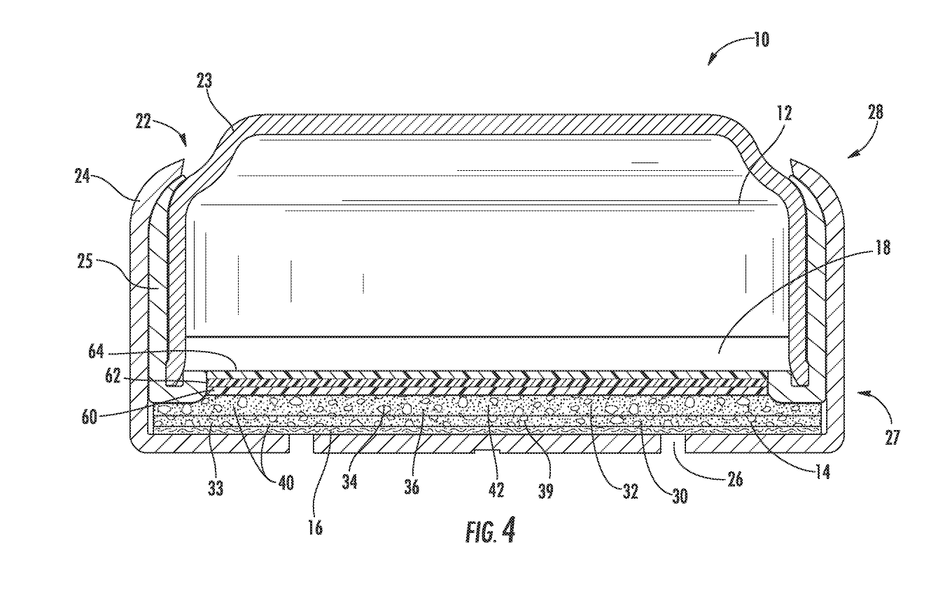

The ion exchange material may also be incorporated into one of the layers of the air electrode 14. FIG. 5 illustrates a detail view of the air electrode 14 according to an exemplary embodiment, and shows that the active layer 32 of the air electrode 14 includes five separate sublayers 70, 72, 74, 76, 78, and 80. According to other exemplary embodiments, the number of sublayers may differ. One or more of the sublayers 70, 72, 74, 76, 78, and 80 may include an ion exchange material integrated therein (the layer may also include, for example, carbon, catalysts, and/or binder materials such as PTFE, alone or in combination with polypropylene (PP), polyethylene (PE), or other polymers). For example, during the formation of the sublayer, the constituents may be mixed together along with the ion exchange material. When the sublayer is subsequently formed (e.g., by printing, spray-coating, spin coating, dip coating, etc.), the ion exchange material fills the pores of the active layer 32 of the air electrode 14 that would normally be filled with liquid (e.g., an electrolyte such as KOH) in a conventional air electrode. In this manner, ion exchange materials may be disposed in hydrophilic channels, form the hydrophilic channels, and/or form substantially the entire hydrophilic structure of the air electrode.

It is intended that the filled pores of the active layer 32 will act to reduce the migration of oxygen from the air electrode to the metal anode, since the pores will be selective to ions passing therethrough while preventing components such as oxygen through the pores.

The use of an ion exchange material within one or more layers of the air electrode may also be effective to provide a more stable three phase boundary in the air electrode by polymerizing the air electrode and preventing flooding of the air electrode and helping to separate the oxygen reduction reaction from the oxygen evolution reaction. By increasing the surface area of the three phase boundary, the ion exchange material may provide an improved current-voltage profile for the air electrode as compared to air electrodes that do not include an ion exchange material.

Inclusion of the ion exchange material within the air electrode may also be effective to limit diffusion of solid particles and cations (e.g., carbon, catalysts, impurities, etc.) into and out of the air electrode. By reducing this diffusion, cross-contamination between the anode and the cathode for a metal air battery can be limited and controlled.

The ion exchange material within the air electrode is intended to be effective to limit (e.g., control, regulate, etc.) the transport of liquids within the air electrode. By reducing the transport of liquids, flooding can be reduced and the lifetime of the air electrode extended. Control over water and OH⁻ transport can be improved by varying the hydrophobicity of the pore structure within the active layer. For example, sub-layers having a high PTFE composition may be located proximate to the gas diffusion layer side of the active layer and sub-layers having a low PTFE composition may be located proximate to the electrolyte side of the active layer. Alternatively, the transport channels can be formed in the active layer by including an ion exchange polymer in the coating material, which is used to create polymer channels within the active layer. When used in coating materials, ion exchange polymers form polymer channels intended to transport the electrolyte or fill the pores of the air electrode polymer material. As a polymer is generally less mobile than a liquid electrolyte, improved control over water and OH⁻ transport can be achieved.

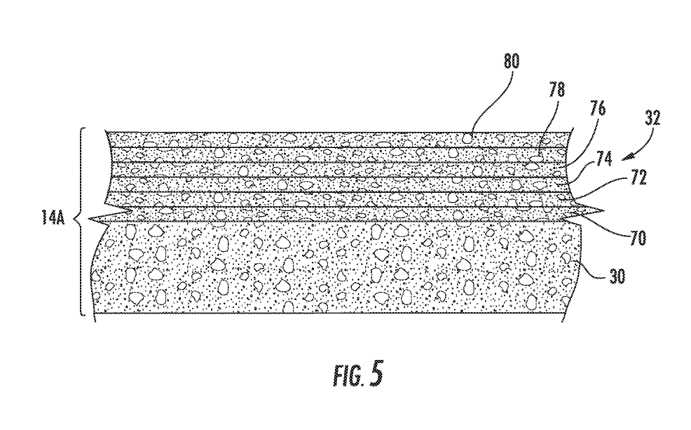

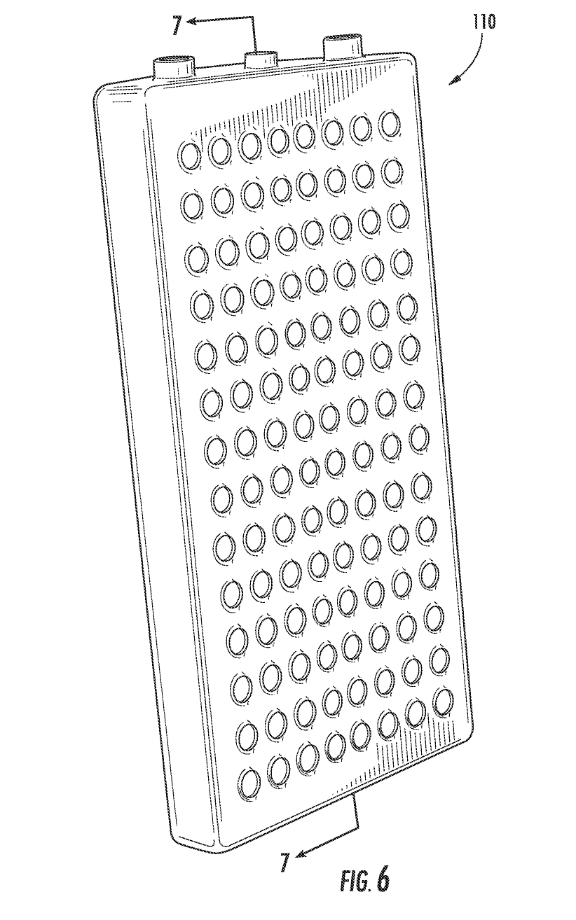

Although FIGS. 1-5 have been described in the context of a button or coin cell type battery, it should be noted that other configurations are also possible for the metal-air battery, and that ion exchange materials such as those described herein may be utilized in a similar manner in such other battery configurations. For example, referring to FIGS. 6-8, a prismatic metal-air (e.g., zinc-air) battery 110 is shown according to an exemplary embodiment. FIG. 7 shows a cross-sectional view of the battery 110, and FIG. 8 shows a detail view of one end of the battery 110 taken across line 8-8 in FIG. 7. The battery 110 includes a housing 122, a metal electrode 112 running along the length of the cell, an air electrode 114 (which includes a gas diffusion layer 130 and an active layer 132, along with a current collector provided therein similar to the current collector 39 described above (not shown)), an electrolyte 118 provided in the space between the metal electrode 112 and the air electrode 114, and a separator 120 between the electrolyte 118 and the air electrode 114. An oxygen distribution layer 116 (similar to that described with respect to the oxygen distribution layer 16 for the coin cell embodiment described above with respect to FIG. 2) may optionally be provided between the air electrode 114 and the housing 122. The upper portion of the housing 122 contains holes 126 (e.g., slots, apertures, etc.) for air to enter the battery 110.

An ion exchange membrane 150 is provided on or adjacent to the surface of the active layer 132 in a manner similar to that described with respect to the ion exchange membrane 50 as shown in FIG. 2 above. Those reviewing the present disclosure will appreciate that the ion exchange materials may be used in and formed in a manner similar to what has been described with respect to the coin or button cell embodiments. Accordingly, it should be understood that similar to the coin or button cell embodiments described herein, the prismatic battery may use an ion exchange material in the pores of the separator, as an ion exchange separator in place of or in addition to a conventional porous polymeric separator, or integrated within a layer or layers of the active layer of the air electrode. As described above with respect to the coin or button cell embodiments, more than one separator may be provided between the air electrode and the metal electrode as described, for example, with respect to FIG. 4.

The air electrode 114 may be secured (e.g., by gluing or welding) to the lid of the housing to prevent leakage. The gas diffusion layer side of the air electrode faces the holes 126 in the battery housing 122, and the oxygen distribution layer 116 is positioned substantially between the gas diffusion layer and the holes 126 in the housing 122. The battery 110 is filled with a metal (e.g., zinc) paste. Current collectors for the air electrode and the metal electrode may be attached using contact pins by resistance welding, laser welding, or other methods known in the art and shielded (e.g., with glue) to prevent gassing in the cell. The housing is then closed off (other than the air holes) (e.g., by ultrasonic welding).

The battery 110 provides for a commercially viable prismatic battery that may be used in numerous applications wherein prismatic batteries are or may be used because battery 110 provides, in addition to a high current density, a lifetime in that is sufficient and/or desirable for these applications (e.g., cell phones, cameras, MP3 players, portable electronic devices, etc.).

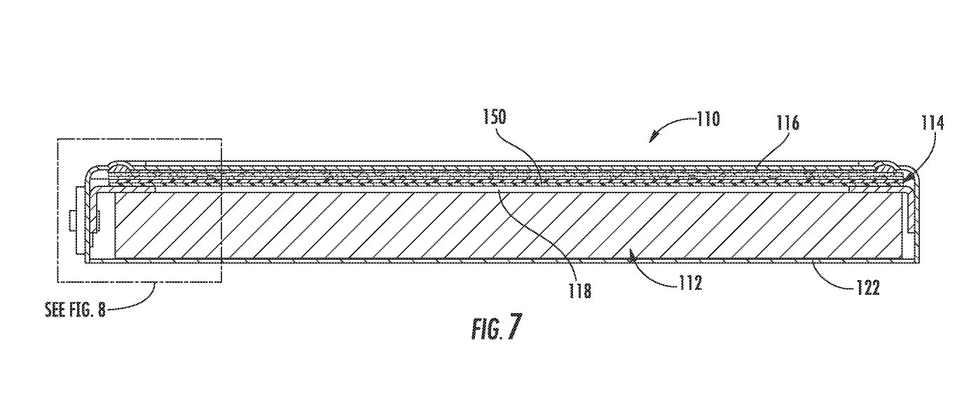

FIG. 9 illustrates an exemplary embodiment of a flow battery 210 similar to those disclosed in International Application PCT/US10/040445 and corresponding U.S. patent application Ser. No. 12/826,383, each filed Jun. 29, 2010, the entire disclosures of which are incorporated herein by reference.

Referring to FIG. 9, a metal-air flow battery shown as a zinc-air flow battery 210 is shown according to an exemplary embodiment. The term “flow battery” is intended to refer to a battery system in which reactants are transported into and out of the battery. For a metal-air flow battery system, this implies that the metal anode material and the electrolyte are introduced (e.g., pumped) into the battery and a metal oxide is removed from or taken out of the battery system. Like a fuel cell, the flow battery system requires a flow of reactants through the system during use.

The zinc-air flow battery 210 is shown as a closed loop system including a zinc electrode 212, an electrolyte 218, one or more storage devices shown as tank or chamber 244, and a reactor 246 having one or more reaction tubes 248, each of the reaction tubes 248 including an air electrode 214 (which, like the air electrodes described above, includes a gas diffusion layer and an active layer).

The zinc electrode 212 is combined with the electrolyte 218 to form a zinc paste 250, which serves as a reactant for the zinc-air flow battery 210 according to an exemplary embodiment. The reactant (e.g., active material, etc.) is configured to be transported (e.g., fed, pumped, pushed, forced, etc.) into and out of the reactor 246. When the zinc-air flow battery 210 is discharging, the zinc paste 250 is transported into the reactor 246 and through the reaction tubes 248 and a zinc oxide paste 252 is transported out of the reactor 246 after the zinc paste 250 reacts with the hydroxyl ions produced when the air electrode 214 reacts with oxygen from the air. When the zinc-air flow battery 210 is charging, the zinc oxide paste 252 is transported into the reactor 246 and through the reaction tubes 248 and the zinc paste 250 is transported out of the reactor 246 after the hydroxyl ions are converted back to oxygen. The pastes 250, 252 are stored in the tank 244 before and after being transported through the reactor 246, the zinc paste 250 being stored in a first cavity 254 of the tank 244 and the zinc oxide paste 252 being stored in a second cavity 256 of the tank 244. According to another exemplary embodiment, the tank 244 includes only a single cavity, and the zinc oxide paste is stored in the single cavity.

As discussed above, the reaction tubes 248 each include an air electrode 214 disposed between at least two protective layers. FIG. 9 illustrates one of the reaction tubes 248 of the zinc-air flow battery 210 in more detail, exploded from the zinc-air flow battery 210 according to an exemplary embodiment. The reaction tube 248 is shown having a layered configuration that includes an inner tube or base 258, a separator 270, the air electrode 214 (including a gas diffusion layer 230 and an active layer 232), and an outer tube or protective casing 262 according to an exemplary embodiment. The base 258 is shown as the innermost layer of the reaction tube 248, the protective casing 262 is shown as the outmost layer of the reaction tube 248, and the other layers are shown disposed substantially between and concentric with the base 258 and the protective casing 262.

An ion exchange membrane 260 is provided on or adjacent to the surface of the active layer of the air electrode 214 in a manner similar to that described with respect to the ion exchange membrane 50 as shown in FIG. 2 above. Those reviewing the present disclosure will appreciate that the ion exchange materials may be used in and formed in a manner similar to what has been described with respect to the coin or button cell and prismatic battery embodiments. Accordingly, it should be understood that similar to the coin or button cell embodiments described herein, the prismatic battery may use an ion exchange material in the pores of the separator, as an ion exchange separator in place of or in addition to a conventional porous polymeric separator, or integrated within a layer or layers of the active layer of the air electrode. As described above with respect to the coin or button cell embodiments, more than one separator may be provided between the air electrode and the metal electrode as described, for example, with respect to FIG. 4.

According to the exemplary embodiment shown, the composition of air electrodes 214 enables production of tubular air electrodes according to an exemplary embodiment. The air electrode 214 includes a plurality of binders 264. The binders 264 provide for increased mechanical strength of the air electrode 214, while providing for maintenance of relatively high diffusion rates of oxygen (e.g., comparable to more traditional air electrodes). The binders 264 may provide sufficient mechanical strength to enable the air electrode 214 to be formed in a number of manners, including, but not limited to, one or a combination of injection molding, extrusion (e.g., screw extrusion, slot die extrusion, etc.), stamping, pressing, utilizing hot plates, calendaring, etc. This improved mechanical strength may also enable air electrode 214 to be formed into any of a variety of shapes (e.g., tubular, etc.).

The tubular configuration of the reaction tubes 248, and, correspondingly, the air electrodes 214, makes the air electrodes 214 relatively easy to assemble without leakage. The tubular configuration in conjunction with the conductive gas diffusion layer permits for the current collectors for the air electrodes 214 to be on the outside of the reaction tubes 248, substantially preventing any leakage from the air electrode current collector. Further, the tubular configuration permits for the current collectors for zinc electrodes 212 to be integrated substantially within reaction tubes 248, eliminating contact pin leakage.

In addition, the tubular configuration of air electrodes a 214 provides improved resistance to pressure, erosion (e.g., during transport of zinc paste 250 and zinc oxide paste 252, etc.), and flooding. For example, the tubular configuration of the air electrode permits zinc paste to flow through a passage defined thereby with less friction than if the air electrode were configured as a flat plate, causing relatively less erosion therewithin. Also, the cylindrical reaction tubes 248 having a layered configuration permits for incorporation of elements/layers providing mechanical stability and helping to provide improved pressure resistance.

During discharge of the zinc-air flow battery 210, the zinc paste 250 is fed from the tank 244 through a zinc inlet/outlet and distributed amongst the reaction tubes 248 by a feed system 272. According to the exemplary embodiment shown, the feed system 272 includes a plurality of archimedean screws 274. The screws 274 rotate in a first direction, transporting the zinc paste 250 from proximate the first end portion 276 toward the second end portion 278 of each reaction tube 248. An air flow 280 is directed by an air flow system 282, shown including fans 284, through a plurality of air flow channels 286 defined between the reaction tubes 248. The air flow 280 is at least partially received in the reaction tubes 248 through a plurality of openings 288 in the protective casing 262 and toward the passage 266, as shown by a plurality of air flow paths 290. Oxygen from the air flow 280 is converted to hydroxyl ions in the air electrode 214; this reaction generally involves a reduction of oxygen and consumption of electrons to produce the hydroxyl ions. The hydroxyl ions then migrate toward the zinc electrode 212 in the zinc paste 250 within the passages 266 of the reaction tubes 248. The hydroxyl ions cause the zinc to oxidize, liberating electrons and providing power.

As a result of its interaction with the hydroxyl ions, the zinc paste 250 is converted to the zinc oxide paste 252 within the reaction tubes 248 and releases electrons. As the screws 274 continue to rotate in the first direction, the zinc oxide paste 252 continues to be transported toward the second end portion 278. The zinc oxide paste 252 is eventually transported from reaction tubes 248 through a zinc oxide inlet/outlet and deposited in the second cavity 256 of the tank 244.

As discussed above, the zinc-air flow battery 210 is rechargeable. During charging, the zinc oxide paste 252 is converted or regenerated back to zinc paste 250. The zinc oxide paste 252 is fed from the tank 244 and distributed amongst the reaction tubes 248 by the feed system 272. The screws 274 rotate in the second direction (i.e., opposite to the direction they rotate during discharging), transporting the zinc oxide paste 252 from proximate the second end portion 278 toward the first end portion 276 of each reaction tube 248. The zinc oxide paste 252 is reduced to form the zinc paste 250 as electrons are consumed and stored. Hydroxyl ions are converted to oxygen in the air electrodes 214, adding oxygen to the air flow 280. This oxygen flows from the reaction tubes 248 through the openings 288 in the protective casing 262 outward from proximate the passage 266, as shown by the air flow paths 290.

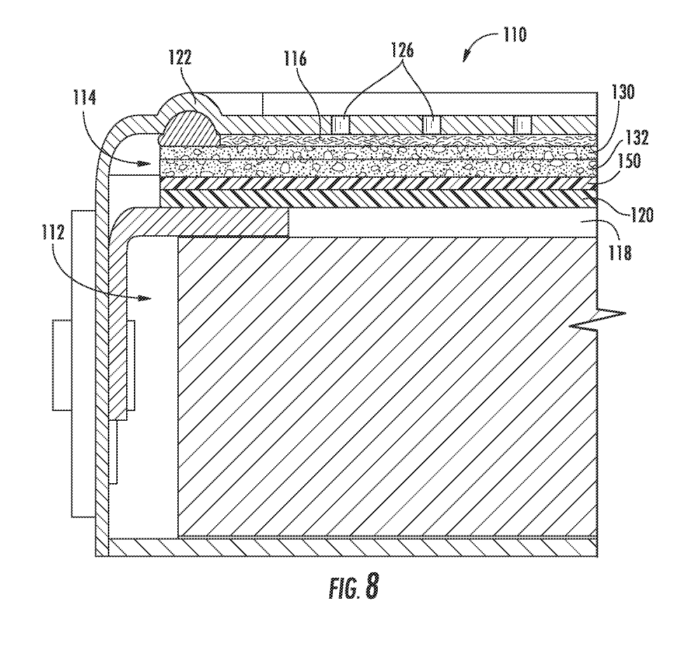

Referring to FIG. 10, another exemplary embodiment of a reaction tube is shown as reaction tube 310.

The reaction tube 310 includes an inner tube 312 and an outer tube 314 according to an exemplary embodiment. The inner tube 312 is shown having a layered structure including four layers; moving outward from a longitudinal axis 316 of the reaction tube 310, these layers are a protective casing 320, an air electrode 322, a separator 324, and a base 326. Similarly, the outer tube 314 is shown having a layered structure including four layers; moving away from the longitudinal axis 316, these layers are a base 330, a separator 332, an air electrode 334, and a protective casing 336. Stated otherwise, moving away from the longitudinal axis 316, the layers of the outer tube 314 are the mirror image for the layers of the inner tube 312.

The inner tube 312 is substantially concentric with and spaced a distance from the outer tube 314, defining an annular passage 340 therebetween according to an exemplary embodiment. The annular passage 340 (e.g., channel, conduit, etc.) is configured to receive an anode paste material (e.g., a zinc paste and/or a zinc oxide paste). Similar to the reaction tube described above, the paste is intended to contact the bases 326, 330 of the inner tube 312 and the outer tube 314 as it moves through the annular passage 340. The paste is intended to be fed or moved through the annular passage 340 by a feed system such as a pump-type feed system.

An air flow 344 is intended to be directed along the reaction tube 310 such that oxygen enters through a plurality of openings 346 in the protective casings 320, 336. In the exemplary embodiment shown, this means that air is directed through a central passage 348 defined by the inner tube 312 and along the exterior surface of the outer tube 314.

This configuration provides a number of benefits, including, but not limited to, allowing for a higher power output to be provided because of the increased surface area of the air electrodes 322, 334. It should be noted that, according to other exemplary embodiments, other suitable layering schemes for the inner tube and the outer tube may be used. Though, it is generally desirable for the layering schemes to provide a relatively large air electrode surface area. In this way, the air electrodes may help provide for a relatively high rate capability/power density.

An ion exchange material may be used in conjunction with the reaction tube 310. For example, similar to the manner in which the pores of a porous polymeric separator may be filled with an ion exchange material (as described above), the openings 346 in the bases 326, 330, which results in the formation of a smooth surface where the metal slurry travels through the reaction tube that prevents metal from penetrating into the perforations of the inner tube that might clog the pore structure, resulting in premature failure of the battery. The ion exchange material is also selective to ion passage, and thus also provides the other benefits described herein with respect to ion selective materials.

According to other exemplary embodiments, the reaction tube 310 may include ion exchange materials in other configurations. For example, an ion exchange membrane may be formed on or adjacent to the separators or the inner and/or outer tubes, an ion exchange membrane may be incorporated in one or more of the active layers of the air electrodes, an ion exchange separator or a separator having an ion exchange material in the pores thereof may be used, and the like. Again, it should be understood by those reviewing this disclosure that the concepts described herein may be applied to any of the battery configurations described herein.

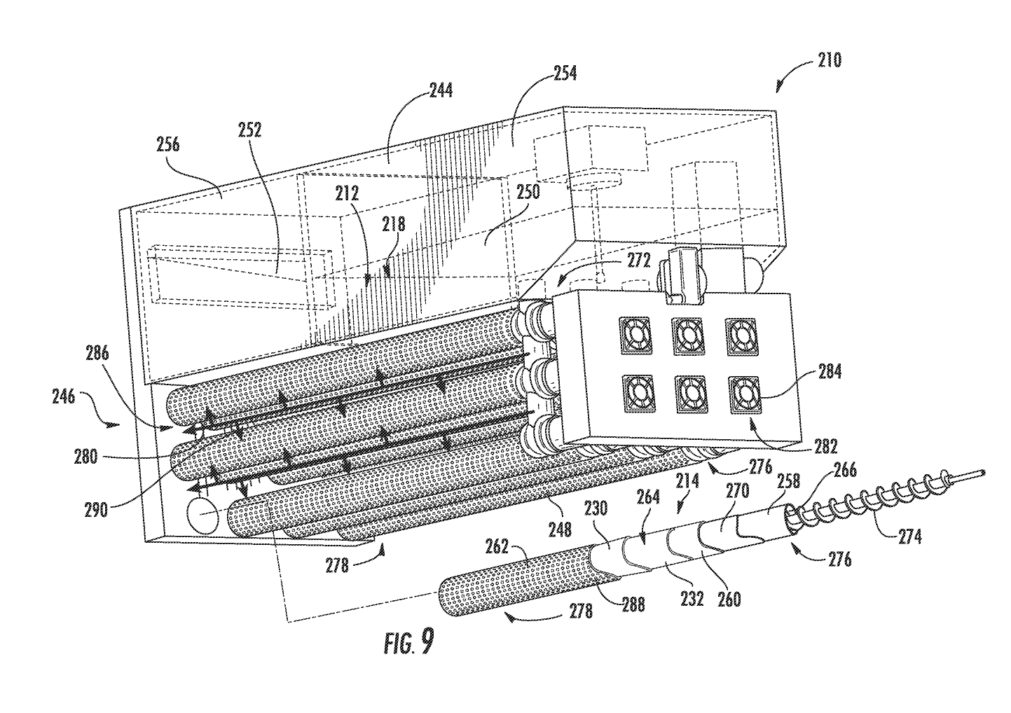

Referring now to FIGS. 11-20, test data illustrating the benefits that may be obtained from using an ion exchange material will be discussed.

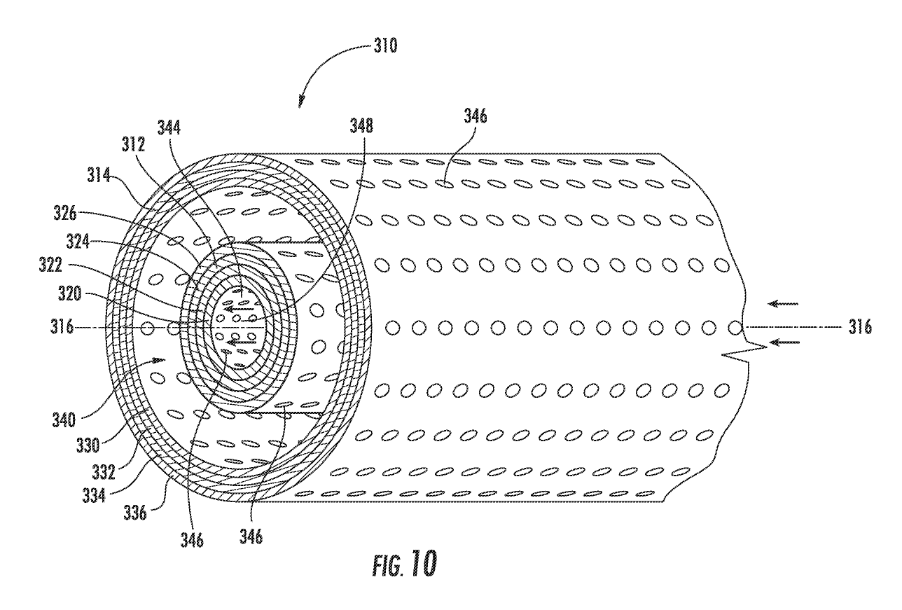

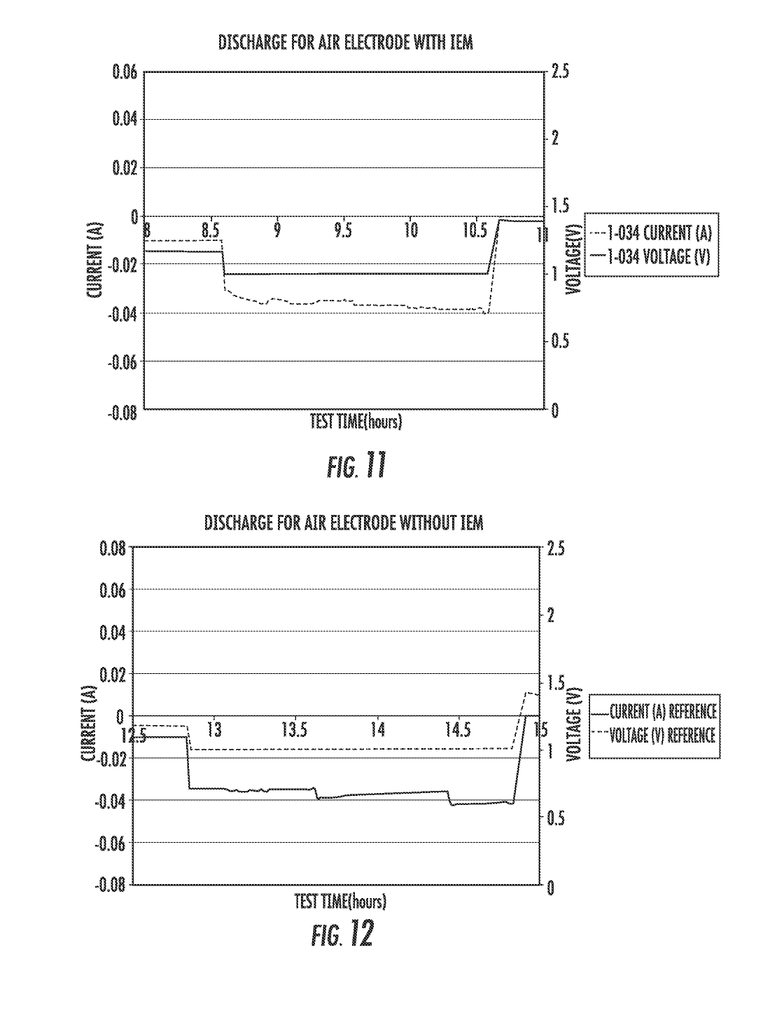

FIGS. 11-14 illustrate the electrochemical performance of air electrodes with and without an ion exchange membrane coated onto active layer of the air electrode. FIGS. 11 and 12 illustrate constant voltage discharge graphs for an air electrode with an ion exchange membrane (FIG. 11) and without an ion exchange membrane (FIG. 12). The ion exchange membrane was formed using a Fumion AM material and was laminated onto the active layer of the air electrode. FIGS. 13 and 14 illustrate current sweeps for the same cells. Together, FIGS. 11-14 illustrate that there is an only insignificant change in the electrochemical performance for air electrodes using the ion exchange membrane compared to the baseline air electrode that does not include an ion exchange membrane. Accordingly, it does not appear that the use of an ion exchange membrane would adversely affect the electrical performance of a metal-air battery.

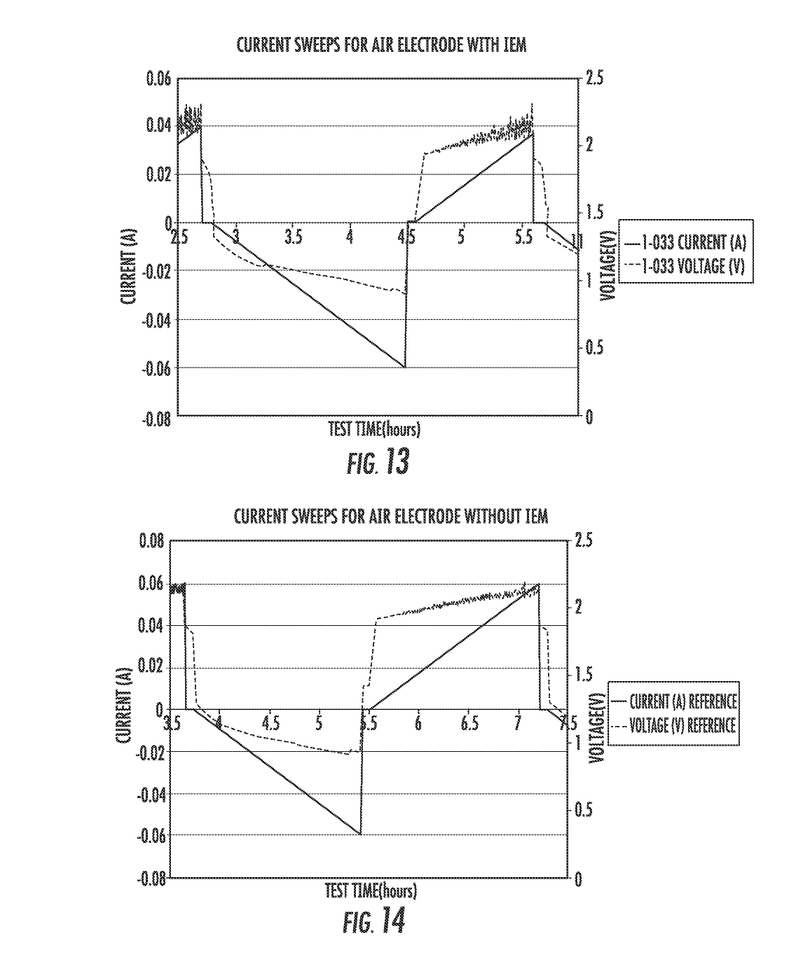

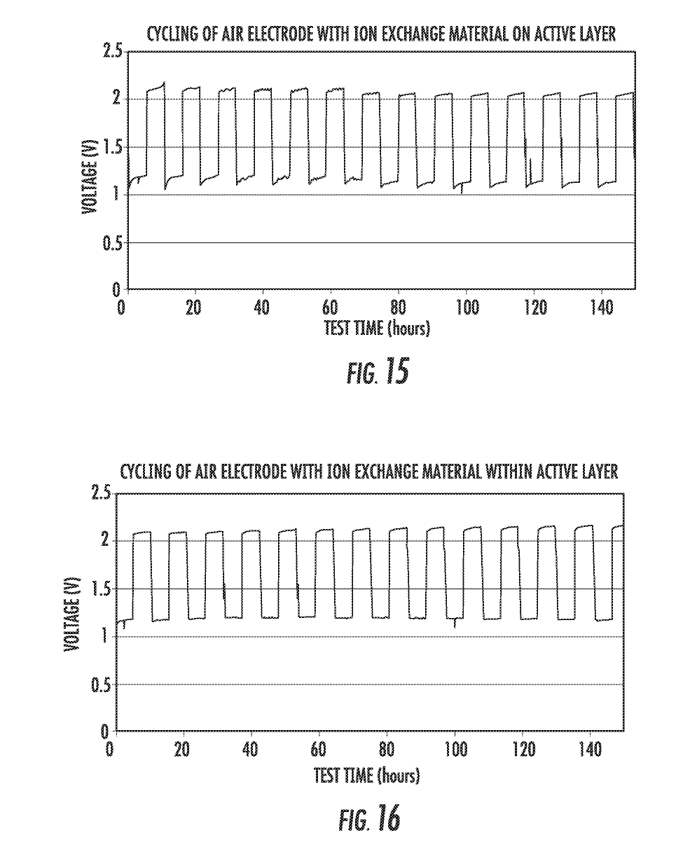

FIGS. 15-17 illustrate charging and discharging data for air electrode half cells with and without the use of ion exchange materials. FIG. 15 illustrates the charging and discharging data for an air electrode that included an ion exchange material (Fumion AM in the form of a membrane laminated onto the air electrode) on the active layer, FIG. 16 illustrates the data for an air electrode having an ion exchange material within the active layer itself (Fumion AM material provided at a 1 weight percent loading level in the active layer of the air electrode), and FIG. 17 illustrates the data for an air electrode that did not include an ion exchange material. The relatively stable cycle performance with the ion exchange material confirms that oxygen is transported out of the air electrode during charging through the gas diffusion layer. Visual inspection of the air electrode after about 20 cycles confirms that no gas entrapment was observed. It is also interesting to observe that the charge voltage for the samples with the ion exchange material provided within the active layer (i.e., FIG. 16) did not show a high charge voltage for the first several cycles (unlike the air electrode without the ion exchange material, as shown in FIG. 17), which may indicate that a pre-activation of such electrodes may not be necessary. This may advantageously allow metal-air batteries to be produced without a pre-activation formation step that is common with more conventional metal-air batteries.

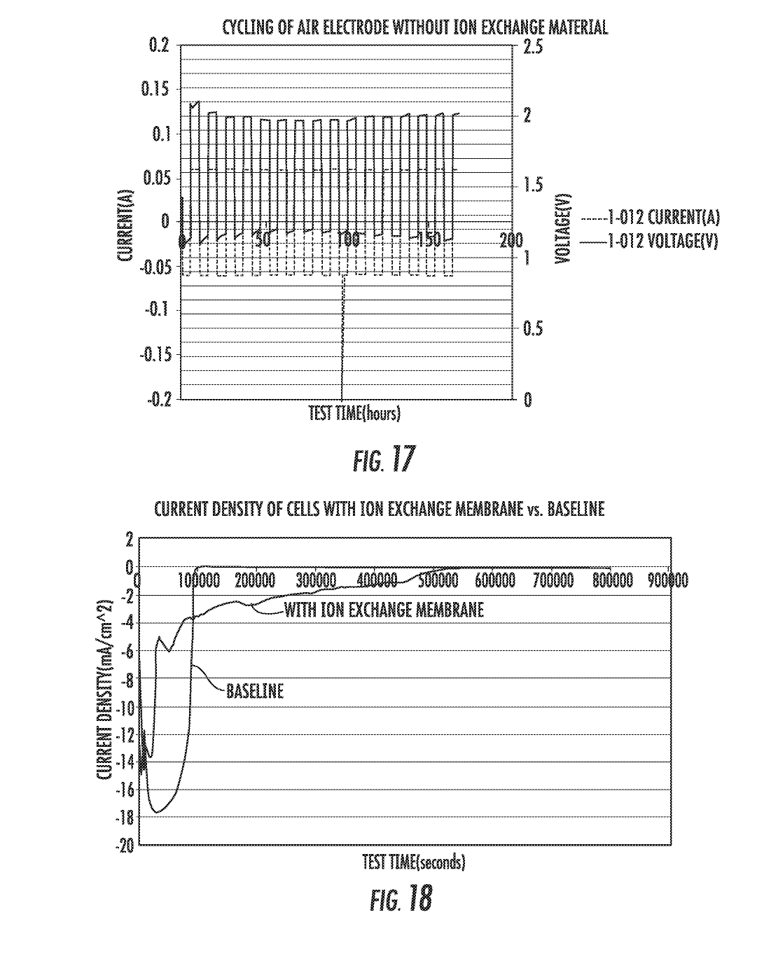

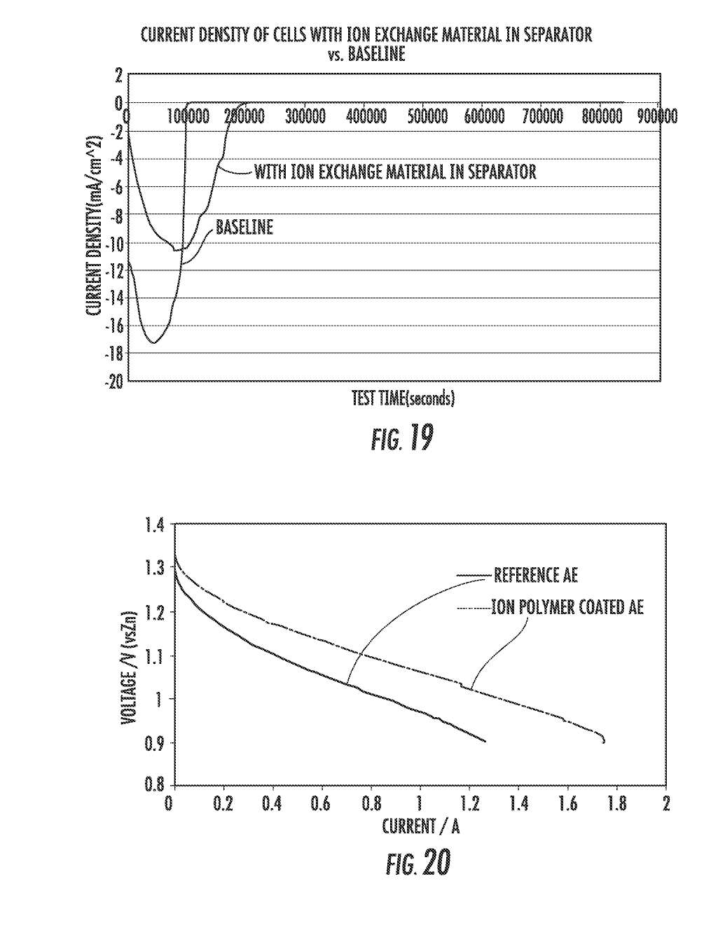

FIGS. 18 and 19 illustrate data representing the current density of coin cells having a variety of different configurations. FIG. 18 illustrates this data for a cell that included an ion exchange membrane (Fumion AM) applied to the air electrode and for a baseline cell that did not include an ion exchange membrane (i.e., it used a standard porous polymeric polymeric separator). FIG. 19 illustrates data for the baseline cell and for a cell having an ion exchange material (Fumion AM) incorporated within the pores of a porous polymeric separator. Although the shapes of the curves differ between the baseline and the two cells using ion exchange materials, the overall capacities of the cells in all three cases was approximately 250 mAh, which indicates that the use of an ion exchange membrane or an ion exchange material within the pores of a porous polymeric separator have little or no effect on the overall capacity of the cells.

FIG. 20 illustrates the results of polarization sweeps for similar air electrodes with and without an ion exchange material coated onto the surface of the air electrodes (half cell data of potential dynamic sweep from high current to low current on electrodes at room temperature and in a 7.5 M OH⁻ type solution such as KOH). The results show that the coated samples provide equal or higher activity than the uncoated samples. This suggests that the use of an ion exchange material may be effective to increase the power density of the air electrode without sacrificing the stability of the air electrode. The larger current observed is suggestive of a larger active surface area within the electrode, and without wishing to be bound to a particular theory, it is believed that the filling of the pores of the air electrode with the ion exchange material from the coating during the assembly process may be effective to increase the active surface area for oxygen reduction.

Zincate diffusion through a conventional porous polymeric separator and through an ion exchange membrane (Fumion AM and Fumion AP materials were both tested as ion exchange membrane materials) were measured and compared. In each case, the separator or membrane was placed between two compartments, each of which included a KOH electrolyte. In the first compartment, 0.94 M zincate was added to the electrolyte, and in the second compartment, no zincate was added. After one hour, the zincate concentration was measured in each of the compartments, and a diffusion ratio was calculated by dividing the zincate concentration in the second compartment by the zincate concentration in the first compartment. A ratio close to 1 would indicate that the zincate diffuses relatively quickly through the membrane from the first compartment to the second compartment, while a ratio close to 0 would indicate a very slow diffusion rate for the zincate. It was determined in this case that the zincate diffusion ratio for the conventional porous polymeric separator was 0.529, while the two ion exchange membranes had a zincate diffusion ratio of less than 0.009. This data indicates that zincate diffusion may be substantially reduced using an ion exchange membrane, which in turn may allow for substantially reduced dendrite formation within metal-air batteries. Because dendrite formation is a major contributor to decreased lifetime of metal-air batteries, the ion exchange membranes would be expected to have a positive effect on overall metal-air battery lifetime.

Those reviewing this disclosure will appreciate that it may be desirable to include an ion exchange material at various locations within a metal-air battery. For example, it may be desirable to include an ion exchange membrane as well as a porous polymeric separator having an ion exchange material within the pores thereof It should be understood that within the scope of this disclosure is included the use of ion exchange materials in any one or more of the locations described herein, such as within an air electrode, within a material coupled to the air electrode, as a separate film or membrane, within pores of a polymeric separator, or elsewhere.

Various combinations of materials, structures, application methods, methods of manufacture, and applications discussed herein may be used within the scope of this disclosure. Also, while the description included herein is primarily directed to batteries, the concepts disclosed also apply to fuels cells and other electrochemical conversion devices having desired configurations.

The metal-air batteries described herein may be used singularly or in combination, and may be integrated into or with various systems or devices to improve efficiency, address energy demands, etc. The metal-air batteries described herein may be used in a wide range of applications. For example, the battery may be used in large systems and devices (e.g., power levels in the kW range), where improving environmental aspects (e.g., the environment external to the battery and the effect of this environment on the chemical reaction within the battery) of the metal-air battery may provide for significant gains in performance (e.g., energy conversion and storage at high efficiency). Also, the battery may be used in smaller systems (power levels in the W range), where advances in consumer electronics provide opportunities for energy conversion and storage provided in a desirable size and having a relatively long lifespan

Coin cells, prismatic cells, and cylindrical cells such as those described herein may be used in any application where such batteries may find utility, including, for example, hearing aids, headsets (e.g., Bluetooth or other wireless headsets), watches, medical devices, and other electronic devices such as (but not limited to) cameras, portable music players, laptops, phones (e.g., cellular phones), toys, portable tools. Metal-air flow batteries can provide energy storage and conversion solutions for peak shaving, load leveling, and backup power supply (e.g., for renewable energy sources such as wind, solar, and wave energy). The flow batteries may allow for the reduction of energy generation related emissions (e.g., greenhouse gases), and may also be used in a manner intended to improve the efficiency of the public utility sector. Flow batteries may also be used in for providing backup power, for example, for residential or commercial buildings such as homes or office buildings. In the automotive context, metal-air flow batteries may also be used to provide motive power for an electric vehicle (e.g., a hybrid-electric vehicle, plug-in hybrid electric vehicle, pure electric vehicle, etc.), to provide backup power for the battery (e.g., as a range-extender), to provide power for other vehicle electric loads such as the electronics, GPS/navigation systems, radios, air conditioning, and the like within the vehicle, and to provide for any other power needs within the vehicle (it should be noted that metal-air batteries having prismatic, cylindrical, or other configurations may also be used to provide power in the foregoing vehicle applications, for example, where a number of batteries are used in conjunction with each other to form a battery pack, module, or system).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure.

It is important to note that the construction and arrangement of the metal-air battery as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present inventions.

What is claimed is:

1. A metal-air battery comprising:
a metal anode comprising at least one of zinc, aluminum, magnesium, iron, and lithium; and
an ion exchange material provided within the battery for controlling material transport within the battery.

2. The metal-air battery of claim 1, further comprising an alkaline electrolyte and an air electrode, wherein the alkaline electrolyte is provided between the metal anode and the air electrode.

3. The metal-air battery of claim 2, wherein the ion exchange material is provided within the air electrode.

4. The metal-air battery of claim 3, wherein the air electrode includes an active layer, and wherein the ion exchange material is provided within the active layer.

5. The metal-air battery of claim 4, wherein the active layer comprises a plurality of sublayers, and wherein the ion exchange material is provided within at least one of the sublayers.

6. The metal-air battery of claim 1, wherein the ion exchange material is provided within a layer of material that is coupled to an air electrode of the metal-air battery.

7. The metal-air battery of claim 6, wherein the air electrode and the layer of material coupled to the air electrode are cylindrical.

8. The metal-air battery of claim 1, wherein the ion exchange material is provided within pores of an air electrode of the metal-air battery.

9. The metal-air battery of claim 1, further comprising a polymeric separator provided between the metal anode and an air electrode, wherein the ion exchange material is provided within pores of the polymeric separator.

10. The metal-air battery of claim 1, wherein the ion exchange material is provided within a polymer electrolyte.

11. The metal-air battery of claim 1, wherein the metal-air battery is a coin cell.

12. The metal-air battery of claim 1, wherein the metal-air battery is a prismatic or cylindrical battery.

13. The metal-air battery of claim 1, wherein the metal-air battery is a flow battery.

14. The metal-air battery of claim 1, wherein the metal-air battery is rechargeable.

15. The metal-air battery of claim 1, wherein the metal-air battery is includes a housing that includes a plurality of holes provided therein to allow oxygen from the surrounding environment to enter the battery to participate in an oxygen reaction.

16. A metal-air battery comprising:
a metal anode;
an air electrode; and
an ion exchange material provided within the battery for controlling material transport within the battery;
wherein the metal-air battery is a rechargeable battery.

17. The metal-air battery of claim 16, wherein the metal anode comprises at least one of zinc, aluminum, magnesium, iron, and lithium.

18. The metal-air battery of claim 16, wherein the ion exchange material is selective to anion transport.

19. The metal-air battery of claim 16, wherein the ion exchange material is provided within the air electrode.

20. The metal-air battery of claim 16, wherein the air electrode includes an active layer, and wherein the ion exchange material is provided within the active layer.

21. The metal-air battery of claim 20, wherein the active layer comprises a plurality of sublayers, and wherein the ion exchange material is provided within a subset of the sublayers.

22. The metal-air battery of claim 16, wherein the ion exchange material is provided within a layer of material that is coupled to the air electrode.

23. The metal-air battery of claim 16, further comprising a polymeric separator provided between the metal anode and the air electrode, wherein the ion exchange material is provided within pores of the polymeric separator.

24. The metal-air battery of claim 16, wherein the metal-air battery is a coin cell, a prismatic battery, or a cylindrical battery.

25. The metal-air battery of claim 16, wherein the metal-air battery is a flow battery.

26. The metal-air battery of claim 16, wherein the ion exchange membrane is provided in the form of an ion exchange membrane.

27. A rechargeable metal-air battery comprising:
a zinc anode;
an air electrode; and
an ion exchange separator provided intermediate the zinc anode and the air electrode.

28. The rechargeable metal-air battery of claim 27, wherein the ion exchange separator is provided as a membrane coupled to the air electrode.

29. The rechargeable metal-air battery of claim 27, wherein the ion exchange separator is spaced apart from the air electrode.

30. The rechargeable metal-air battery of claim 27, further comprising an alkaline electrolyte between the zinc anode and the separator.

31. The rechargeable metal-air battery of claim 27, wherein the battery is a coin cell, a prismatic battery, or a cylindrical battery.

32. The rechargeable metal-air battery of claim 27, wherein the battery is a flow battery.
